(19) United States
(12) Patent Application Publication
(10) Pub. No.: US 2006/0291190 A1
(43) Pub. Date: Dec. 28, 2006

(54) Backlight module

(75) Inventor: Yi-Shiuan Tsai, Kaohsiung City (TW)

Correspondence Address: BIRCH STEWART KOLASCH & BIRCH, PO BOX 747, FALLS CHURCH, VA, 22040-0747, US

(73) Assignee: AU Optronics Corp.

(21) Appl. No.: 11/472,303

(22) Filed: Jun. 22, 2006

(30) Foreign Application Priority Data
Jun. 24, 2005 (TW) 94121264

(51) Int. Cl. G09F 13/04

(52) U.S. Cl. 362/97; 362/632; 362/633

(57) ABSTRACT

A backlight module comprises a chassis, a fluorescent lamp and a supporter; the fluorescent lamp is disposed on the chassis and the supporter is disposed under the chassis to support the fluorescent lamp, the supporter further has an electrode layer physically connecting to the fluorescent lamp.

### BACKGROUND OF THE INVENTION

(1) Field of the Invention

The invention relates to an backlight module, and more particularly to a backlight module having an electrode layer on its supporter.

(2) Description of the Prior Art

Liquid Crystal Display (LCD), is previously applied in portable electronic product such as notebook PC, cell phone, digital camera, digital video machine or Personal Digital Assistant (PDA).

The backlight module is one of important part within a LCD. The backlight module provides all the light that the liquid crystal panel demanding, hence it affects the whole quality of a LCD. Therefore, kinds of optical films are disposed upon the backlight module to enhance the resolution of LCD.

There are kinds of light sources used in a backlight module, one common light source is cold cathode fluorescent lamp (CCFL). The basic structure of a CCFL is a hermetically sealed glass tube which is filled with discharging gas. There is a fluorescent layer scribbled evenly on the inner wall of the said glass tube. A pair of internal electrodes is disposed on two opposite ends of the glass. While alternating currents are conducted into the glass tube, the emitted ultraviolet from discharging gas excites the fluorescent to emit visible light.

Another light source named external electrode fluorescent lamp (EEFL) is also common because its longer lifetime and better luminous efficiency. The electrode of the EEFL is disposed outside the lamp; hence the lamp won't get injury after longtime using. Furthermore, only one inverter is needed to drive a plurality of EEFLs, but every lamp of CCFLs needs one inverter itself, hence the power is saved comparing the EEFLs to CCFLs.

However, while fabricating larger LCDs, no matter an EEFL or a CCFL face a problem that the longer the lamp is, the larger working voltage and driving voltage are. The cost of inverters is substantially rising. In addition, the high working and driving voltage may cause the wall of glass tube breaking.

### SUMMARY OF THE INVENTION

It is an object of the present invention to provide a backlight module, which may lower the working voltage and start voltage of the fluorescent lamp therein.

In the present invention , the backlight that is workable to add a supporter and an external electrode on the fluorescent lamp and drive different portions of the fluorescent lamp alternatively thus lowering the tube voltage of the fluorescent lamp. Moreover, the location that a supporter supports the fluorescent lamp is variable, thus increasing the design elasticity. In some embodiments of the present invention, the backlight module further comprises an upper supporter, which may enhance the driving efficiency and provide support to the diffusion upon the fluorescent lamp. The present invention not only provides a mode of effective power saving, but also a mode easy and convenient to fabricate and carry on.

### BRIEF DESCRIPTION OF THE DRAWINGS

The present invention will now be specified with reference to its preferred embodiment illustrated in the drawings, in which

FIG. 1A is the first embodiment of the backlight module 2 in accordance with the present invention;

FIG. 1B is an explosion diagram of the fluorescent lamp 21 and a supporter 22;

FIG. 1C is diagram of a supporter of another embodiment of the present invention;

FIG. 2 is a working principle diagram of the first embodiment of the present invention;

FIG. 3 is a side-view diagram of a second embodiment of the present invention.

FIG. 4 shows the relationship between the fluorescent lamp and the supporter of the third embodiment of the present invention.

FIG. 5 shows the relationship between the fluorescent lamp and the supporter of the fourth embodiment of the present invention

FIG. 6 is a front view of the backlight module of a better embodiment of the present invention.

### DESCRIPTION OF THE PREFERRED EMBODIMENT

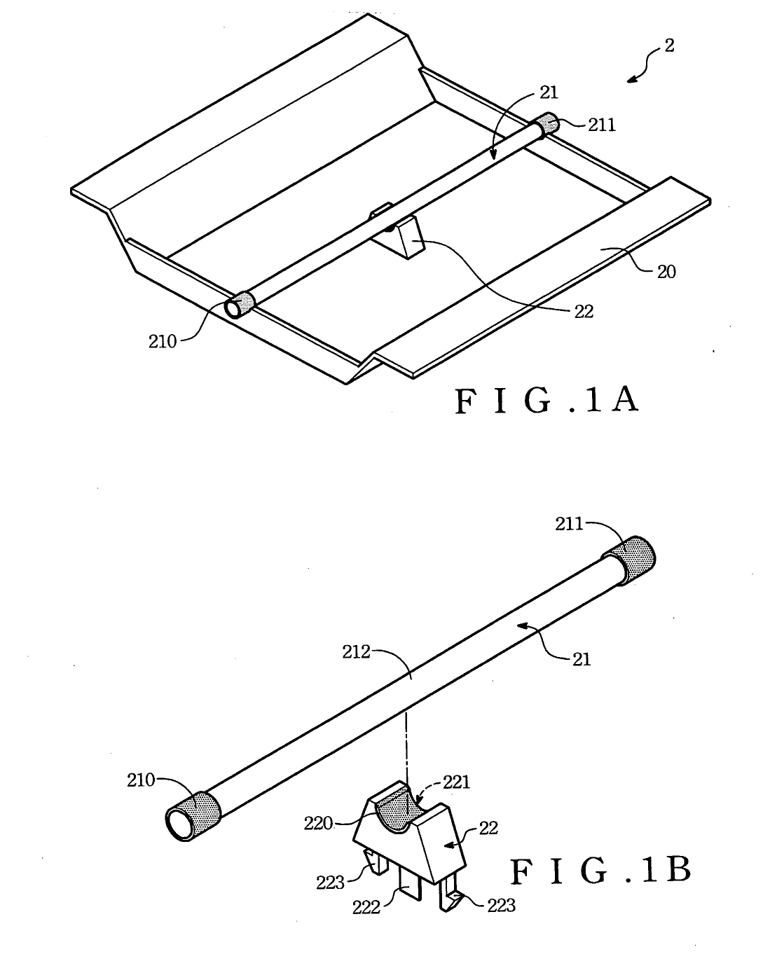

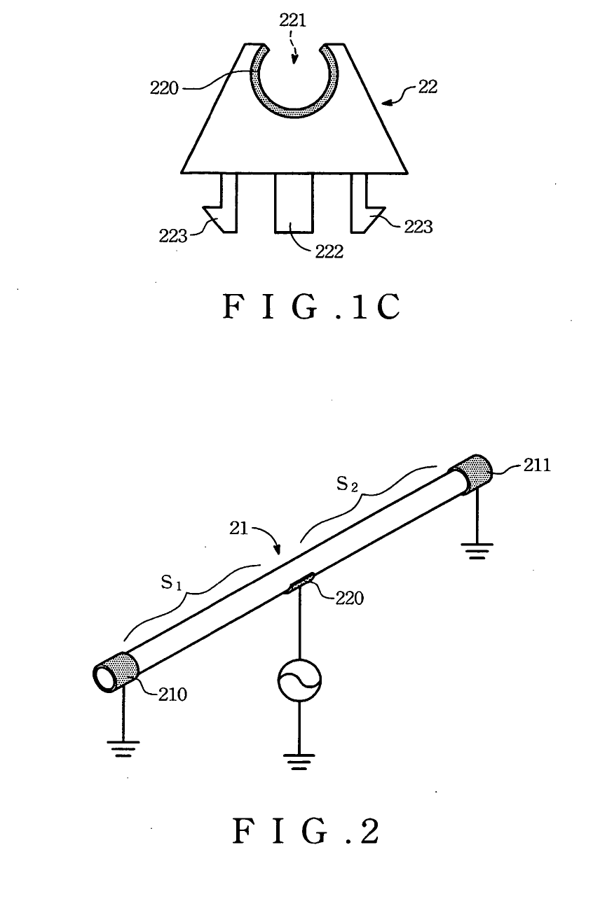

FIG. 1A is the first embodiment of the backlight module 2 in accordance with the present invention. The backlight module 2 comprises a chassis 20, a fluorescent lamp 21 and a supporter 22. In this embodiment, the fluorescent lamp 21 is an external electrode fluorescent lamp (EEFL), wherein two opposite ends of the fluorescent lamp 21 are disposed on the chassis 20. There is a pair of external electrodes disposed on two opposite ends of the fluorescent lamp 21; herein the two external electrodes are the first electrode 210 and the second electrode 211 respectively.

FIG. 1B is an explosion diagram of the fluorescent lamp 21 and a supporter 22, the supporter is fixed on the chassis. There's an electrode layer 220 disposed on the surface of the supporter 22, the electrode layer 220 is made of conductive materials such as metal materials like Nickel (Ni), Niobium (Nb) or Tungsten (W).

A large measure of the contact area between the electrode layer 220 and the fluorescent lamp 21 is preferred for lowering the fever of the electrode layer 220 and increasing the driving efficiency of the electric field. In better embodiments, the top aspect of the supporter 22 is not a flat but a fillister portion 221, the electrode layer 220 is disposed on the surface of the fillister portion 221 to increase the measure of the contact area; moreover, the fillister portion 221 may position the fluorescent lamp 21. The design of the fillister portion 221 is variable in different embodiments, herein the shape of the fillister portion is semicircle, but in other embodiments, the shape may be varied arcs.

Referring to FIG. 1C, the material of the supporter 22 has character of a bit elasticity, hence the fillister portion 221 is arc shaped like “C” and formed like a loop to contact tightly with the fluorescent lamp 21 as shown in FIG. 1C.

Additionally, the supporter 22 further comprises a supporter electrode 222 and a plurality of buckles 223. The supporter electrode 222 physically connects to the electrode layer 220 for power supply from an external power source; herein the supporter electrode is a conducting wire. The buckles 223 are located on the bottom of the supporter 22, and there are corresponding buckles disposed on the chassis 20 corresponding to the buckles 223 for buckling in. Thus the assembling process of the supporter 22 is convenient. Other equivalent fixing elements are workable to applied herein to achieve the goal of fixing the supporter 22 on the chassis 20.

FIG. 2 shows the working principle of the first embodiment. After the electrode layer 220 contacts tightly to the wall of the fluorescent lamp 21, the light fluorescent lamp 21 is divided into two emitting portion, S1 and S2. Conduct an alternating current into the electrode layer 220 while the first electrode 210 and the second electrode 211 is grounding. With the alternate changing of voltage and polarity, the emitting portion S1 and S2 are emitted alternatively. By shortening area of the emitting portion of the lamp, the working voltage is decreased effectively.

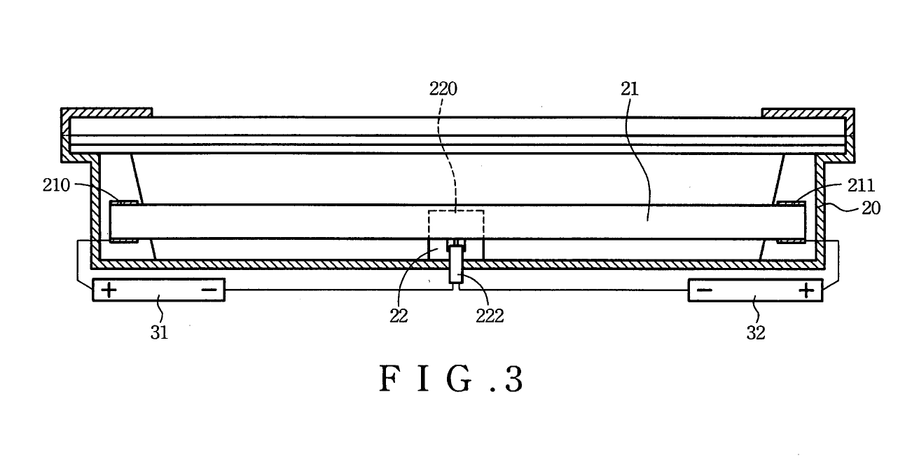

FIG. 3 is a side-view diagram of a second embodiment of the present invention. The backlight module of the second embodiment is alike the structure of the one in the first embodiment and is also driven by turns. The difference is that there are two inverters for driving the fluorescent lamp 21. As FIG. 3 shows, there's an inverter 31 connecting to the first electrode 210 and the supporter electrode 222, an inverter 32 connecting to the second electrode 211 and the supporter electrode 222.

By sequential switching the inverters, the portion between the first electrode 210 and the electrode layer 220, and the portion between the second electrode 211 and the electrode 220 are driven alternatively.

The supporter 22 is not only used for driving the fluorescent lamp alternatively, but also used for supporting the fluorescent lamp 21 from being deformed. The lamp of the related art has problems that sinking phenomenon of middle and raising phenomenon of two opposite ends. However, with the existence of the supporter, the fluorescent lamp of the present invention don't have mentioned problems. In addition, the lamp of the present invention may be EEFL, CCFL, or bare lamps that having no electrodes.

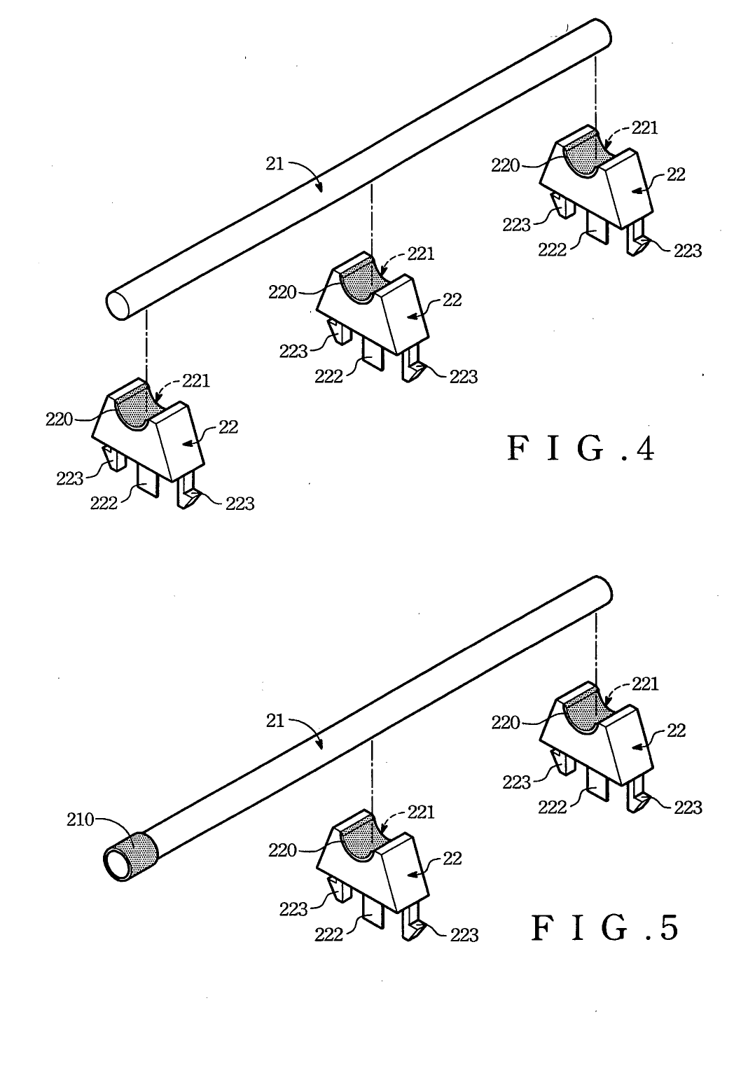

FIG. 4 is a third embodiment of the present invention, herein a fluorescent lamp and a plurality of supporters are used in the embodiment.

The fluorescent lamp 21 is a bare lamp that having no electrodes. The backlight module in FIG. 4 comprises three supporters 22, the supporters 22 support the fluorescent lamp via the supporter electrodes 220 on arbitrarily point of the fluorescent lamp.

FIG. 5 shows a fourth embodiment of the present invention. In this embodiment, there is only a first electrode 210 on one end of the fluorescent lamp 21, and there are two supporters 22 supporting the opposite end and middle of the fluorescent lamp 21 respectively.

From the third and the fourth embodiments described above, the present invention provides a supporter that is easy to be fabricated and assembled. Moreover, the supporter of the present invention is suitable for kinds of lamps common on markets, the supporter provides not only a supporting function but also an alternate driving function.

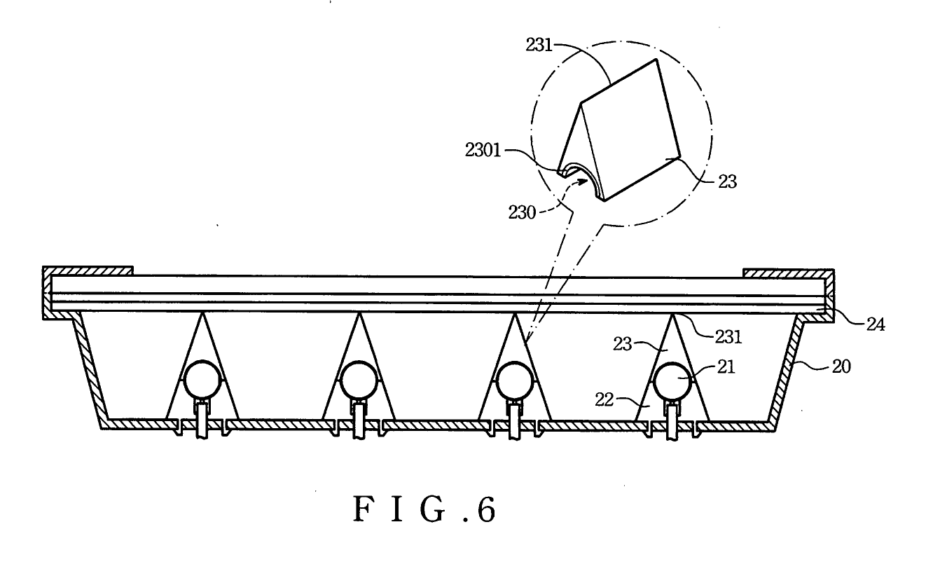

FIG. 6 is a front-view diagram of a better embodiment of the present invention. Herein the backlight module 2 comprises a plurality of fluorescent lamps 21 and a plurality of lower supporters 22 to support the plurality fluorescent lamps 21, the amounts of the lower supporters are the same with the fluorescent lamps.

The backlight module 2 further comprises an upper supporter 23, wherein the amplified diagram is a stereo picture of the upper supporter 23. The base of each upper supporter 23 has a fillister portion 230 having an electrode layer 2301, and the fillister portion is semicircle shaped. In this embodiment, the shape of the fillister portions 221 and 230 of the lower supporters and the upper supporters are semicircle, hence the electrode layers 2301 and 220 of the upper supporter and the lower supporter will encompass the fluorescent lamp 21 after the two supporters overlapping and a complete circle electrode layer forms.

The addition of the upper supporter 23 completes the electrode layer around the fluorescent lam, and further adding the measure of contact area between the fluorescent lamp 21 and the electrode layer contacting to the fluorescent lamp 21, hence increasing the driving efficiency of the electric field.

Practically, the backlight module 2 also comprises a diffusion plate 24 disposed upon the fluorescent lamp 21. The sizes of the diffusion plate become larger while the size of panel getting larger, thus the middle of the lamp within the backlight module is easy to deform. The upper supporter 23 of the present invention can also solve this problem;

the upper supporter 23 may support the diffusion plate 24 from being deformed. In better embodiments, the shape of the upper supporter is a triangle pillar roughly which is better for positioning on the lower supporter 22 and lowering cover of the diffusion plate 24.

To sum up, the present invention provides a backlight that is workable to add a supporter and an external electrode on the fluorescent lamp, and drive different portions of the fluorescent lamp alternatively, thus lowering the tube voltage of the fluorescent lamp. Moreover, the location that a supporter supports the fluorescent lamp is variable, thus increasing the design elasticity. In some embodiments of the present invention, the backlight module further comprises an upper supporter, which may enhance the driving efficiency and provide support to the diffusion upon the fluorescent lamp. The present invention not only provides a mode of effective power saving, but also a mode easy and convenient to fabricate and carry on.

While the present invention has been particularly shown and described with reference to a preferred embodiment, it will be understood by those skilled in the art that various changes in form and detail may be without departing from the spirit and scope of the present invention.

What is claimed is:

1. A backlight module, comprising:
a chassis;
a fluorescent lamp disposed on the chassis; and
a supporter disposed on the chassis to support the fluorescent lamp, the supporter having an electrode layer physically connected to the fluorescent lamp.

2. The backlight module of claim 1, wherein the supporter further has a fillister portion, wherein the electrode layer is disposed on the surface of the fillister portion.

3. The backlight module of claim 2, wherein the fillister portion is semicircle shaped.

4. The backlight module of claim 2, wherein the fillister portion is arc shaped.

5. The backlight module of claim 1, wherein the supporter further having a first buckle disposed on the supporter, and a second buckle corresponding to the first buckle disposed on the surface of the chassis.

6. A backlight module, comprising:
a chassis;
a fluorescent lamp, disposed on the chassis, having a first electrode and a second electrode respectively disposed on two opposite ends of the fluorescent lamp respectively; and
a supporter disposed on the chassis between the first electrode and the second electrode to support the fluorescent lamp, the supporter having an electrode layer physically connected to the first electrode of the fluorescent lamp.

7. The backlight module of claim 6, wherein the fluorescent lamp is a cold cathode fluorescent lamp (CCFL).

8. The backlight module claim 6, wherein the fluorescent lamp is an external electrode fluorescent lamp (EEFL).

9. The backlight module of claim 6, there's absent of other electrodes of the fluorescent lamp between the first electrode and the second electrode.

10. The backlight module of claim 6, wherein the supporter further has a fillister portion, and the electrode layer is disposed on the surface of the fillister portion.

11. The backlight module of claim 10, wherein the fillister portion is semicircle-shaped.

12. The backlight module of claim 10, wherein the fillister portion is arc-shaped.

13. The backlight module of claim 6, wherein the supporter further has a first buckle disposed on the supporter, and a second buckle corresponding to the first buckle disposed on the surface of the chassis.

14. A backlight module, comprising:
a chassis;
a fluorescent lamp, disposed on the chassis, having a first electrode and a second electrode disposed on two opposite ends of the fluorescent lamp respectively;
a diffusion plate disposed upon the fluorescent lamp;
a lower supporter disposed on the chassis between the first electrode and the second electrode to support the fluorescent lamp, the lower supporter having an first fillister portion with an electrode layer physically connected to the first electrode of the fluorescent lamp; and
an upper supporter, disposed upon the supporter, having a second fillister portion positioned corresponding to the first fillister portion, the upper supporter supporting the under surface of the diffusion plate.

15. The backlight module of claim 14, wherein the second fillister portion has an electrode layer physically connecting to the fluorescent lamp.

16. The backlight module of claim 14, wherein the first fillister portion and the second fillister portion are semicircle-shaped.

17. The backlight module claim 14, wherein the upper supporter is a triangle pillar supporting the diffusion plate.

18. The backlight module of claim 14, wherein the supporter further has a first buckle disposed on the supporter, and a second buckle corresponding to the first buckle disposed on the surface of the chassis.
